(19) United States
(12) Patent Application Publication
(10) Pub. No.: US 2012/0051714 A1
(43) Pub. Date: Mar. 1, 2012

(54) SURVEILLANCE AND RECORDING DEVICE

(75) Inventor: Michael Gerhard Reimnitz, Cleveland (AU)

(73) Assignee: TS AUSTRALIA PTY LTD, Cleveland, QU (AU)

(21) Appl. No.: 13/319,082

(22) PCT Filed: May 6, 2010
(86) PCT No.: PCT/AU10/00530

§ 371 Date: Nov. 4, 2011

(30) Foreign Application Priority Data
May 6, 2009 (AU) 2009901986

(51) Int. Cl. H04N 5/77

(52) U.S. Cl. 386/226; 386/E05.069

(57) ABSTRACT

A surveillance and recording device includes a housing. A controller is arranged in the housing. An image recording device is arranged in the housing and operatively connected to the controller. A memory is arranged in the housing and connected to the controller to store image data generated by the image recording device. A power management unit is connected to the controller and configured to manage at least two sources of power. At least one communications port is connected to the controller, a communications port being configured at least for connection to a wireless modem to enable wireless communication with the controller from a remote location.

### FIELD OF THE INVENTION

This invention relates to a surveillance and recording device.

### BACKGROUND OF THE INVENTION

Conventionally, alarm systems with cameras comprise at least five components. These include a control panel (communication centre), keypad, movement sensor, siren/strobe and camera. The devices are normally hardwired but could also be connected wirelessly (using the 2.4 GHz crowded frequency) in a closed environment.

The setup is carried out manually on the control panel which is connected to a telephone line and each peripheral device including the keypad has to be set individually as well. Most of the standard surveillance/alarm systems are analogue and mains power is required at least for the control panel, the camera and the siren/strobe. This requires additional wiring or an available power source.

It follows that conventional remote alarm and surveillance systems can be relatively costly. Hardwiring over a long distance can be both costly and time consuming. Furthermore, the cost of power RF transceivers can be high as well. Video footage is often viewed by security personnel on a continuous basis at a monitoring station and is recorded onto endless videotapes or hard disk drives for later observation which can also be time-consuming. Such monitoring stations are generally always required when there is a plurality of cameras positioned, installed and wired in various areas, i.e. to monitor traffic, airports, big supermarkets, stations etc.

However, it will be appreciated that a relatively low cost surveillance solution would be applicable for remote signal areas which require surveillance. Generally, home or shop alarm/surveillance systems are either costly or the installation is complicated and time-consuming. For example, a home and shop alarm/surveillance system has to be installed by a qualified technician which involves labour costs and even after market regular service costs. In this regard, the more sensors and detectors that are installed the more potential problems exist.

Security systems that require outdoor positioning can be both labour and cost intensive. Furthermore, the cost of the materials used for such systems can be high.

### SUMMARY OF THE INVENTION

According to a first aspect of the invention, there is provided a surveillance and recording device which comprises

a housing;

a controller arranged in the housing;

an image recording device arranged in the housing and operatively connected to the controller;

a memory arranged in the housing and connected to the controller to store image data generated by the image recording device;

a power management unit connected to the controller and configured to manage at least two sources of power; and

at least one communications port connected to the controller, a communications port being configured at least for connection to a wireless modem to enable wireless communication with the controller from a remote location.

The housing may have a pair of covers, each cover including complementary connecting formations configured to permit assembly or disassembly of the cover by hand.

The image recording device may be in the form of a camera capable of recording video or successive still images.

The wireless modem may be one of a GSM, HSPA and WLAN modem. The wireless modem may be in the form of a USB device to permit “plug and play” operation of the modem. The controller may be configured to control operation of the modem such that the image data can be communicated by the modem to a remote device. The modem may be configured to use mobile or cellular telephone protocols such that the image data can be communicated to devices connected to the Internet. The modem may also be configured to use WLAN protocols. The modem may be in the form of interchangeable GSM/HSPA and WLAN modems. It follows that the device of the invention can be identified with a number unique to that device, such as a conventional mobile or cellular phone number.

An event sensor is arranged in the housing and is operatively connected to the controller such that the image recording device can be actuated when an event is sensed by the sensor. The event sensor may be a motion detector.

The controller may be configured to write data relating to event times to the memory in the form of markers to enable retrieval of image data generated at said event times.

A transceiver may be arranged in the housing and operatively connected to the controller to permit wireless communication with peripheral devices.

The peripheral devices may be one or more of a number of sensors, including a movement sensor, a magnetic switch, a gas sensor, a fire detector, smoke detector, flood sensor, vibration sensor or any other suitable sensor. The transceiver may be configured to receive trigger signals from the peripheral devices and to transmit actuating signals to other peripheral devices such as alarms or spotlights.

The communications port may be in the form of a USB port, the controller being configured to permit plug 'n play operation of devices connected to the port.

The controller may be configured to communicate with one of a GSM, HSPA and WLAN modem and may be configured to use wireless protocols.

The controller and transceiver may configured so that the transceiver can receive trigger signals from the peripheral devices and transmit actuating signals to other peripheral devices on receipt of said trigger signals. The controller and transceiver may also be configured so that the transceiver can assume a sniff mode to detect wireless signals at predetermined signals.

The controller and transceiver may further be configured so that the transceiver can communicate with the peripheral devices using an encrypted hopping frequency.

The controller may be configured to generate a message according to a mobile messaging protocol carrying information relating to a peripheral device triggered by an event to be communicated by the wireless modem.

The controller and modem may be configured so that the modem is capable of receiving transmitted data representing instructions from a remote location.

In one embodiment the controller may be configured so that an SMS message can be sent with the modem carrying information relating to the identity of a peripheral device triggered by an event. In a further embodiment, the controller may be configured to send an MMS message to at least one remote device and an e-mail message with an appropriate attachment to at least one remote computer or monitor station. The modem may be configured to receive instructions from a remote location by SMS such that the controller can control operation of various peripheral devices and the image recording device itself. Instead, or in addition, the controller may be remotely programmable with a computer to actuate various components or peripheral devices at predetermined times.

In one embodiment, the controller may be configured to communicate with the modem to receive instructions by SMS to extract image data from the memory and to communicate the image data to computers or monitor stations via WLAN or to mobile devices such as cellular phones via a cellular network. Said image data may be the image data associated with particular event times demarcated by the markers.

The controller may be configured to communicate with the modem to receive instructions to extract image data from the memory and to communicate the image data to computers or monitor stations via WLAN or to mobile devices via a cellular network.

The device may include a sound recording device connected to the controller so that the sound recording device can be actuated by the controller when the controller receives a trigger signal from a sensor or a peripheral device. The controller may be configured so that the sound data can be communicated in a similar way to the image data.

The power management unit may include a solar panel, two internal and separate rechargeable batteries and power management circuitry for controlling power from the two batteries and from the solar panel. The controller may be operatively connected to the power management circuitry and programmed so that the power management circuitry controls power selection from either of the two batteries. The power management circuitry may be configured to receive two sources of power, one from the solar panel and one from a DC source. The circuitry may include a power path selector for selecting a power or current path either to power out or to a charging arrangement for charging the batteries.

The invention extends to a software product with which the controller may be programmed.

The controller may be programmed so that the power management circuitry controls power from the two batteries and the integrated solar panel by trickle charge. In particular, the power management circuitry is configured so that the device of the invention can operate substantially indefinitely with solar power.

The controller may be programmed so that a number of components are shut down when not in use, a number of components are placed into a standby or “sleep” condition and at least one sensor is maintained in an awake state such that the components can be activated when a triggering signal is generated by the sensor.

The device of the invention may include an infra-red (IR) spotlight for night operation. The IR spotlight may be connected to the controller to be activated when a triggering signal is generated by a sensor, typically a passive infra-red (PIR) sensor.

The device of the invention may include a light sensor connected to the controller so that the controller can control operation of the image recording device to accommodate lighting conditions and to enhance image recordal.

The device of the invention may include a USB port to permit a computer to be connected directly to the device so that recorded data can be downloaded to the computer. The software product of the invention may also be configured to permit the controller to be programmed and to permit the exchange of firmware and setup software between the controller and the computer.

The device of the invention may include an analogue output terminal. This enables an analogue monitor to be connected to the device to facilitate correct positioning of the device.

The software product of the invention may include setup software to facilitate starting of various applications. The setup software may be configured to obviate the need for a user manual.

According to a second aspect of the invention, there is provided a software product for use with the recording and surveillance device of the first aspect of the invention, the software product being configured so that, when executed by the controller of the device, the device carries out the following steps:

actuating the camera to be in a condition suitable for recording images;

actuating the event sensor to be in a detection mode such that, when an event is detected, the camera records images of the event;

processing the images subsequent to recording the images; and

transmitting data representing the images wirelessly to a remote location subsequent to processing the images.

A method for recording and surveillance of events using the device of claim 1, the method comprising the steps of:

actuating the image recording device to be in a condition suitable for recording images;

recording images of an event with the image recording device on receipt of a trigger signal at the controller;

processing the images; and

subsequent to processing the images, transmitting data representing the images wirelessly to a remote location.

The method may include the step of receiving the trigger signal from a peripheral device operatively connected to the controller.

The method may include the step of communicating wirelessly with the controller from a remote location using a wireless modem connected to the controller.

The method may include the step of writing data relating to event times to the memory in the form of markers to enable retrieval of image data generated at said event times.

The invention is now described, by way of example, with reference to the accompanying drawings. The following description is solely for the purpose of illustrating to a person of ordinary skill in the art, how to put an embodiment of the invention into practice. As such, it is not intended to narrow the scope of the preceding paragraphs or the appended claims.

### BRIEF DESCRIPTION OF THE DRAWINGS

FIG. 1 shows a schematic diagram of one embodiment of a surveillance and recording device, in accordance with the invention.

FIG. 2 shows a schematic block diagram of the surveillance and recording device.

FIG. 3 shows a three dimensional view of the device.

FIG. 4 shows a block diagram of a power management unit of the device.

FIG. 5 shows a USB expansion module of the device.

FIG. 6 shows another three dimensional view of the device.

FIG. 7 shows a flowchart indicating a start-up operation of the device.

FIG. 8 shows a flowchart indicating operation of the device as a still image intrusion detection device.

FIG. 9 shows a flowchart indicating fixed interval still image operation of the device.

FIG. 10 shows a flowchart indicating fixed interval video imaging operation of the device.

FIG. 11 shows a flowchart indicating operation of the device as a video imaging intrusion detection device.

FIG. 12 shows a flowchart indicating a setting operation carried out on the device.

FIG. 13 shows another embodiment of a surveillance and recording device, in accordance with the invention.

### DETAILED DESCRIPTION OF THE DRAWINGS

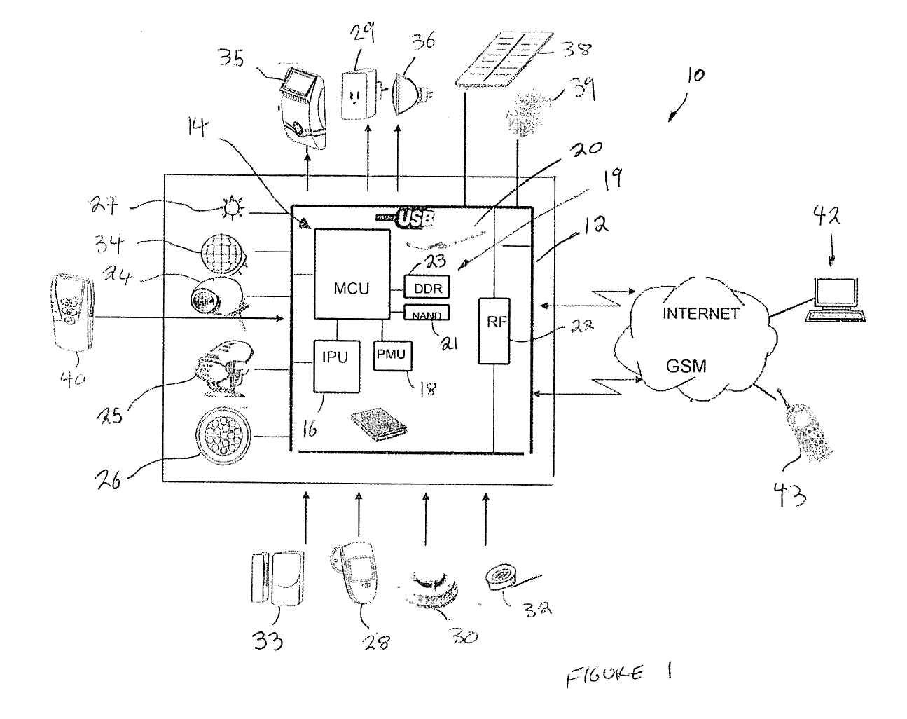

In FIG. 1, reference numeral 10 generally a surveillance and recording device, in accordance with the invention.

The device 10 includes a housing, schematically indicated at 12. A controller 14 is positioned in the housing 12. An image processing unit 16, a power management unit 18 and a solid state digital video recorder in the form of memory 19 having NAND and DDR SDRAM memories 21, 23 respectively are connected to the controller 14. The video recorder can also be in the form of a removable memory card or a solid state drive. A wireless modem 20 in the form of a USB wireless modem is connected to the controller 14. A radio signal transceiver 22 is also connected to the controller 14.

An image recording device in the form of a digital camera 24 is connected to the controller 14 and image processing unit 16. Other internally positioned peripheral devices include a microphone 25, an integrated infra-red (IR) array 26, a light sensor 27, and a passive infra-red (PIR) motion sensor 34. These are all connected to the controller 14. Externally positioned peripheral devices including a spotlight 36, a PIR motion sensor 28, a smoke detector 30, a gas sensor 32, a magnetic switch 33, an AC switch 29, a siren/strobe 35, a DC power supply 39 and a solar panel 38 are connected to the controller 14. The DC power supply 39 and the solar panel 38 are connected to the power management unit 18.

The device 10 includes a remote control arrangement 40 to permit remote control of 35 the device 10.

The modem 20 has a WLAN component to permit the controller 14 to communicate with computers and other devices. The modem 20 also has a mobile or cellular telephony component to permit the controller to communicate with a remote computer or monitoring station 42 via the Internet or with a mobile communications device 43. The cellular telephony component may be selected so that the modem 20 can communicate using cellular protocols such as GSM and 3G.

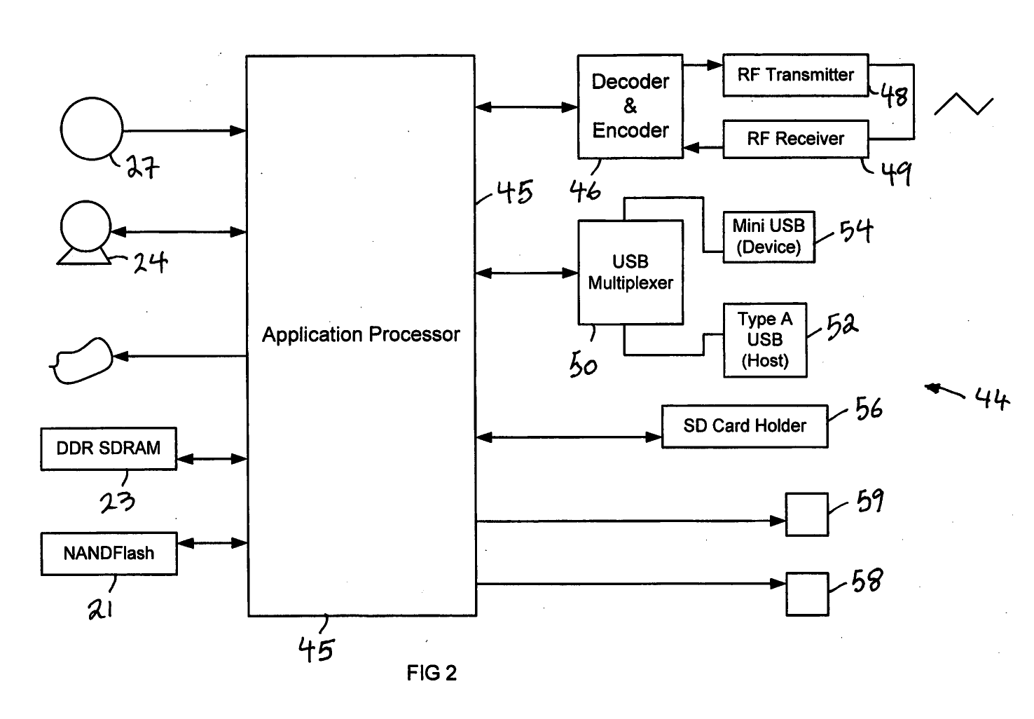

In FIG. 2, reference numeral 44 generally indicates a block diagram of the device 10. The controller 14 includes an application processor 45. With reference to FIG. 1, like reference numerals refer to like parts unless otherwise specified. The transceiver 22 includes an encoder/decoder 46 connected to the processor 45. An RF transmitter 48 and an RF receiver 49 are both connected to the encoder/decoder 46.

A USB multiplexer 50 is connected to the processor 45. A pair of USB ports in the form of a type A USB (host) port 52 and a mini USB (device) port 54 is connected to the multiplexer 50. One of the ports can be used to connect a GSM/EDGE/HSPA USB modem for communication with mobile devices or monitoring stations, while the other can be used to connect a Bluetooth modem for closer communication, such as with peripheral devices.

An SDIO card holder 56 is connected to the processor 45. The processor 45 is also configured for connection to peripheral devices such as a monitor 58 and speakers 59.

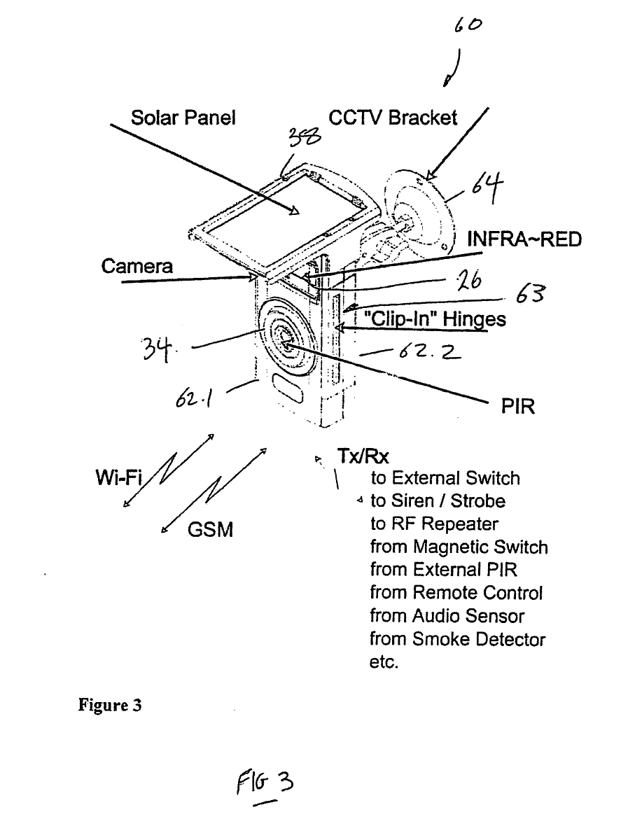

In FIG. 3, reference numeral 60 generally indicates an external three dimensional view of the device 10. With reference to FIGS. 1 and 2, like reference numerals refer to like parts, unless otherwise specified.

The housing 12 has a pair of covers in the form of a front cover 62.1 and a rear cover 62.2 that are connected together with “clip-in” hinges 64, to facilitate assembly and disassembly. In particular, the hinges 64 allow the housing 12 to be assembled or disassembled by hand, without the need for tools. The covers 62 are configured so that the housing 12 is suitable for outdoor use and is substantially weatherproof. Furthermore, the covers 62 define windows and vents and include optical lenses to protect the camera 24, the light sensor 30 27, the PIR sensor 34, the microphone 25 and the IR array 26.

The device 10 can be provided in a weatherproof case which comprises two parts that are screwed together with at least 4 screws at respective corners and sealed with a gasket.

The solar panel 38 is mounted on the covers 62. The motion sensor 34 is mounted to extend through the front cover 62.1, as is the camera 24 and the PIR sensor 26.

A bracket 64 is mounted on the rear cover 62.2 so that the device 10 can be mounted in a suitable location.

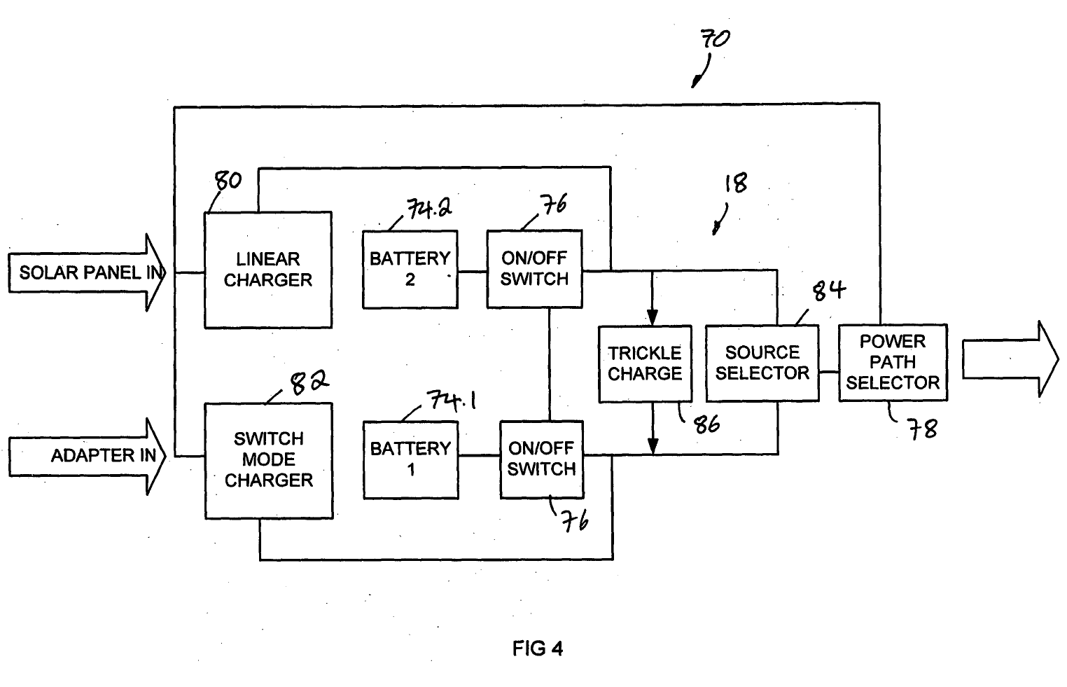

In FIG. 4, reference numeral 70 generally indicates a block diagram indicating operation of the power management unit 18 by the controller 14 programmed with a software product of the invention.

The device 10 includes a first rechargeable battery 74.1 and a second rechargeable battery 74.2. Respective on/off switches 76 connect or disconnect the batteries 74 from the power management unit 18.

The power management unit 18 is configured to receive two sources of power, one from the solar panel and the other from a DC adapter 72. The unit 18 includes a power path selector 78 for selecting a power or current path either to power out or to a linear charger 80 and a switch mode charger 82. The unit 18 further includes a battery source selector 84 so that either of the batteries 74 can be selected for power supply. A trickle charge unit 86 is connected to the batteries 74 so that they can be continually trickle charged either from the solar panel 38 or a DC power supply from the DC adapter 72.

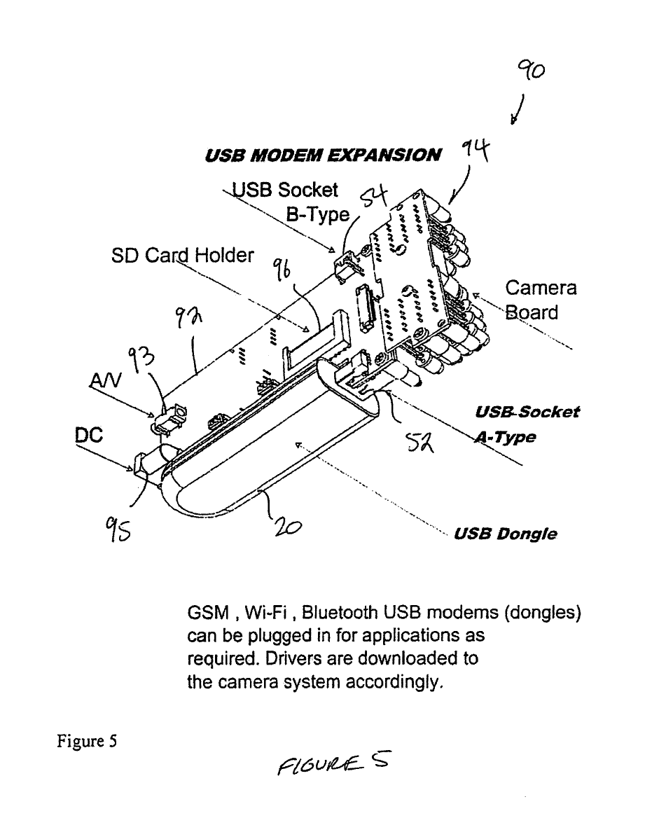

In FIG. 5, reference numeral 90 generally indicates a USB modem expansion unit 25 configured to permit the connection of the wireless modem 20 to the processor 45. With reference to FIGS. 1 to 4, like reference numerals refer to like parts unless otherwise specified.

The unit 90 includes a circuit board 92. The circuit board 92 includes a camera board 94 with circuitry for the camera 24. A secure digital (SD) card holder 96 is arranged on the circuit board 92 for receiving an SD card. The unit 90 also includes an audio-visual (AJV) connector 93 and a DC power supply connector 95. As shown in the figure, the wireless modem 20 is plugged into the type A USB socket 52.

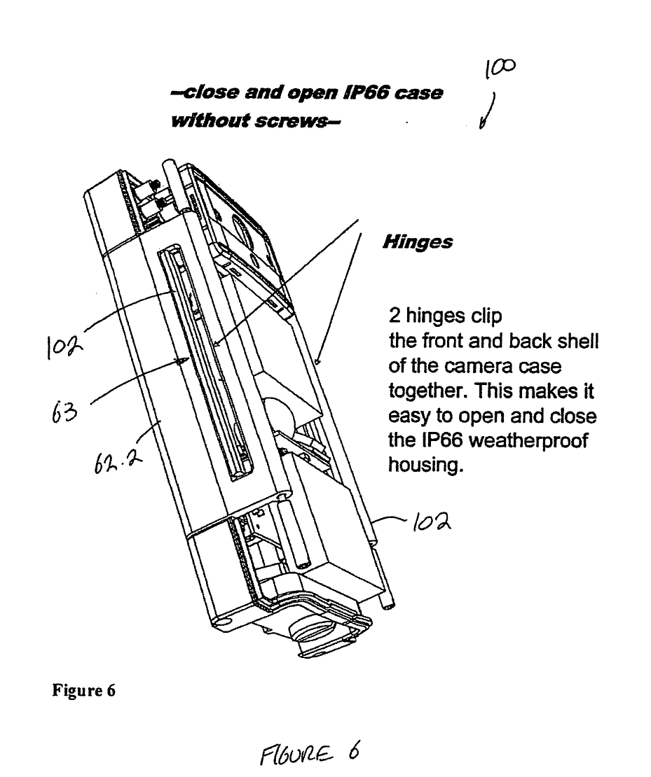

In FIG. 6, reference numeral 100 generally indicates another three dimensional view of the device 10.

In the drawing, just the rear cover 62.2 is shown. The rear cover 62.2 has a pair of opposed hinge connectors 102 that are configured to clip onto complementary connectors of the front cover 62.1. Thus, screws are not required and this can be done by hand.

In FIG. 7, reference numeral 110 generally indicates a flowchart of one example of a start up operation carried out with the device 10 when the controller 14 is programmed with a software product of the invention.

At 112 the process is initiated. At 114 the controller 14 carries out a power-on self check. At 116, the controller 14 generates a query as to the presence of the SD card. If 10 the query returns a negative, the controller 14 mounts internal memory at 118. If the query returns a positive, the controller 14 mounts the SD card at 120. In this regard, it is to be noted that the word “mount” is given the meaning that it would have in relation to a UNIX or Linux-based system.

At 122, the controller reads the settings previously input. At 124, the controller 14 queries whether or not the settings are found. If the query returns a negative, the controller 14 enters a video mode at 126. If the query returns a positive, the controller 14 starts operation of the device at 128. The start up process ends at 130. As part of the start up process, the controller 14 can operate to put the transceiver 22 into sniff mode to save power. The controller 14 can also operate to put the transceiver into another power-saving mode.

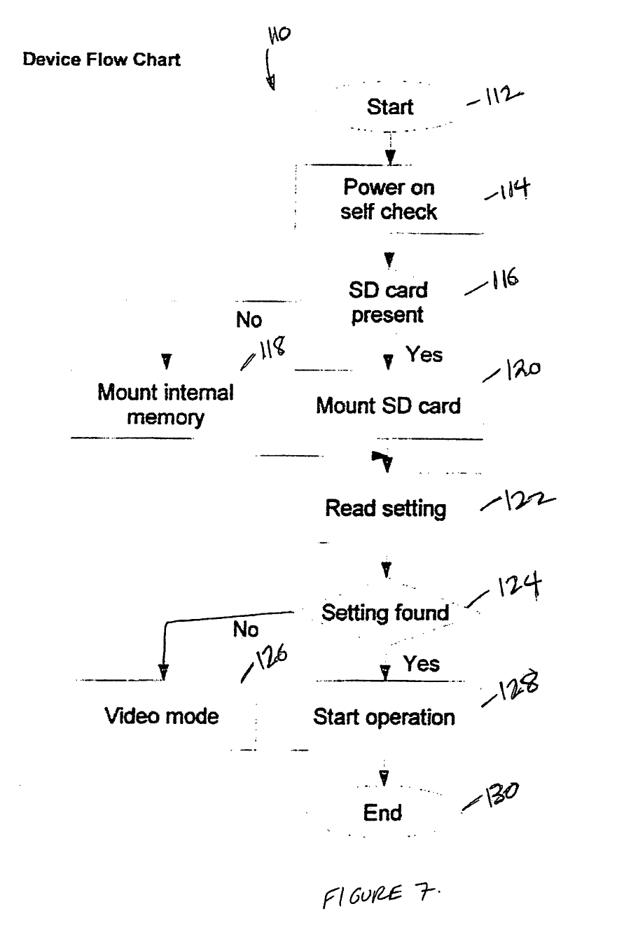

In FIG. 8, reference numeral 140 generally indicates one example of the device 10 being used for the detection of intrusion, when the controller 14 is programmed with 20 the software product of the invention.

The operation starts at 142. At 144 the controller 14 controls the PIR motion sensor 34 such that the sensor 28 is in an operative state. At 146, the controller queries whether or not movement has been detected. If the query returns a negative, the controller 14 returns to the state at 146. If the query returns a positive, the controller 14 instructs the camera 24 to capture a predetermined number of images at 148.

At 150, the image processing unit 16 carries out image post processing. At 152, the controller 14 communicates the resultant image data to a predetermined recipient.

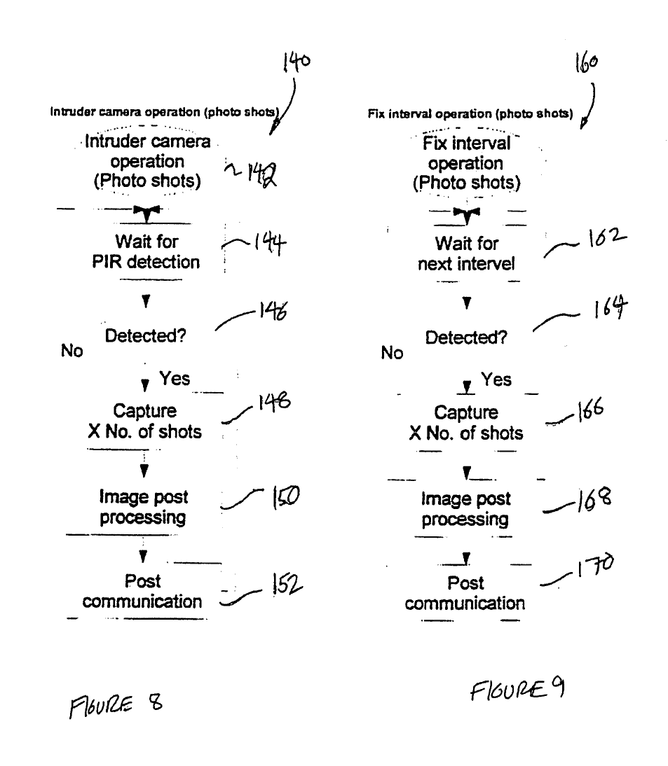

In FIG. 9, reference numeral 160 generally indicates one example of the device 10 being used for fixed interval operation.

The operation starts at 162 at which the controller awaits the start of a predetermined interval. At 164, the controller 14 queries whether or not the interval has started. If the query returns a negative, the controller 14 assumes the state indicated at 162. If the query returns a positive, the controller 14 instructs the camera 24 to capture a pre-determined number of images at 166.

At 168, the image processing unit 16 carries out image post processing. At 170, the controller 14 communicates the resultant image data to a predetermined recipient.

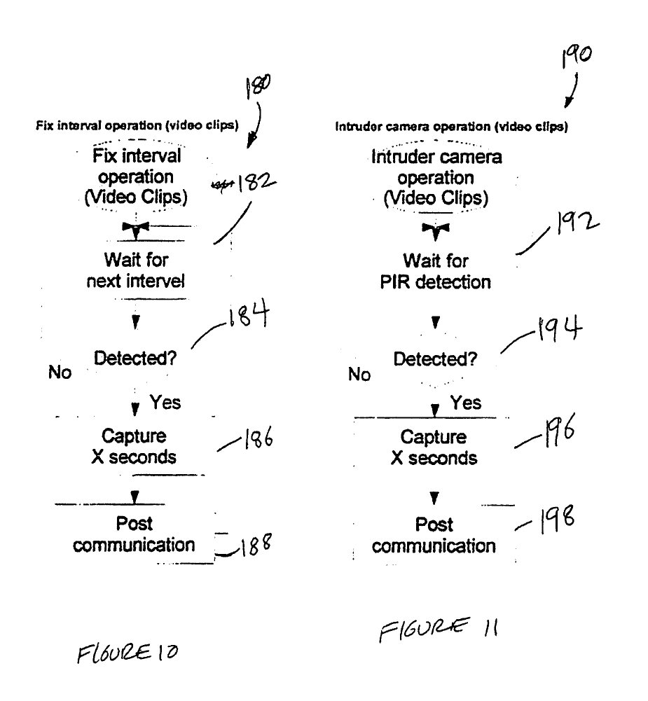

In FIG. 10, reference numeral 180 generally indicates another example of the device 10 being used for fixed interval operation. The operation starts at 182 at which the controller 14 awaits the start of a predetermined interval. At 184, the controller queries whether or not the interval has been detected. If the query returns a negative, the controller returns to the state at 182. If the query returns a positive, the controller 14 controls the camera 24 to carry out an image capture operation for a predetermined length of time at 186. At 188, the controller 14 communicates the resultant image data to a predetermined recipient.

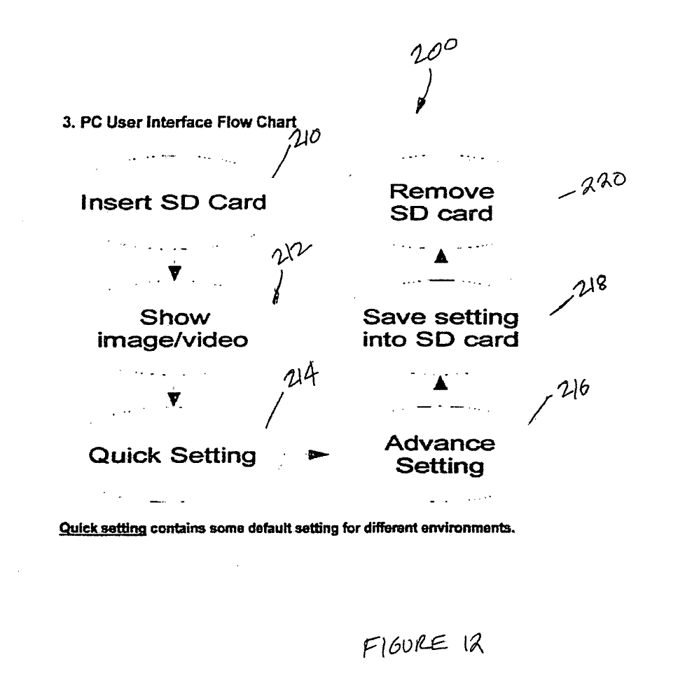

In FIG. 11, reference numeral 190 generally indicates another example of the device 10 being used for intrusion detection.

The operation starts at 192 in which the controller 14 is in a wait state in which it awaits a trigger signal from the motion sensor 34 which would indicate the detection of movement. At 194, the controller 14 queries whether or not movement is detected. If the query returns a negative, the controller 14 returns to the state at 192. If the query returns a positive, the controller 14 controls the camera 24 such that the camera 24 performs an image capture operation for a predetermined length of time at 196. At 198, the controller 14 communicates the resultant image data to a predetermined recipient.

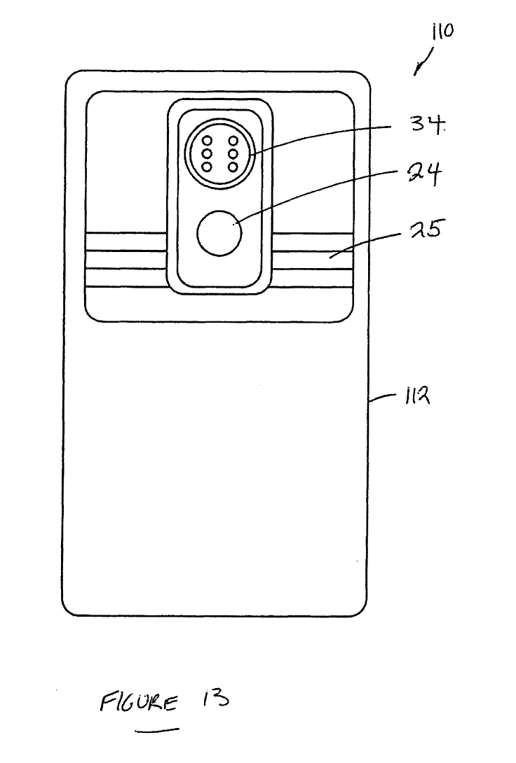

In FIG. 12, reference numeral 200 generally indicates a computer user interface flowchart which indicates a set up operation for the device 10. At 210, the user inserts an SD card into the card holder 56 shown in FIG. 5. At 212, the controller generates a suitable image or video clip on a monitor of the computer so that a quick setting step indicated at 214 can be carried out. At 216, an advanced setting step can be carried out. At 218, the settings are saved into the SD card. At 220, the SD card is removed.

As described above, the invention extends to a software product which is configured to be programmed into the controller 14 such that the controller 14 can perform various operations with the components of the device 10. One of these is the power management unit 18. Peripheral devices such as the USB 35 modem 20 which can be in the form of an HSPA or a WiFi modem, the RF transceiver for the remote control arrangement 40 and for wireless switching use relatively high power when in operation. Without control, these devices would drain batteries at an unacceptable rate. The software product is such that when programmed the controller 14 is capable of setting such devices into a “sleep” mode or a sniff mode. Furthermore, in some cases, the controller 14 can shut the devices down completely if they are not required temporarily. In this embodiment, the controller 14 is connected to the motion sensor 34 which is always in standby mode. Furthermore, the transceiver 22 can be set to a low-power or sniff mode to keep wireless connectivity to various peripherals if this is required.

The software product is configured so that the power management unit 18 can operate to power up the device 10 with only one battery. Thus, the device 10 can include a socket for the second battery 74.2 to permit the user optionally to extend the operating hours of the device 10.

The software product is configured so that the power management unit 18 operates automatically to select the second battery 74.2 to power up the device 10. When the second battery voltage drops to a predetermined level (for example 3.5 V), the battery source selector 84 enters into an auto-switch mode, in which it is configured to select the battery with the higher voltage as a supply source for the device 10.

The power management unit 18 incorporates a hysteresis feature such that repeated switching from one supply to another is avoided. In one example, a threshold for switching from the battery 74.1 to the battery 74.2 is set to 0.15V. As a result, it is only when a voltage of the second battery 74.2 is higher than 3.65 V, will the battery source selector switch back to the second battery 74.2 as the primary power supply source.

The trickle charge unit 86 provides a path for the second battery 74.2 to charge the first battery 74.1 slowly so that the first battery voltage stays at a certain level where the first battery 74.1 alone can sustain the device 10 when the device 10 has a number of its 30 components in the “sleep” state referred to earlier.

The power path selector 78 is configured to switch off the battery power supplies to the device 10 when the adapter 72 is connected to the device 10. Furthermore, in this condition, the selector 78 is configured so that the batteries 74 are charged. As will be understood, power available from a solar panel is largely dependent on 35 the environment in which the solar panel is located. Thus, the chargers 80, 82 are configured dynamically to adjust a charging current drawn from the solar panel 38. In particular, the power management unit is configured to monitor an output voltage of the solar panel to determine the maximum allowable charging current drawn from the solar panel. In one embodiment, the optimum voltage point is found to be about 4.7 V for an 11 cell solar panel. In this embodiment, if the solar panel voltage drops below 4.7 V during charging, the chargers 80, 82 automatically reduce the charging current in order to maintain this voltage level. Furthermore, if the current output from the solar panel is at a sufficiently high level, the chargers 80, 82 charge the batteries 74 at their maximum charging current, for example, at 1 A.

The chargers 80, 82 are also configured so that when the adapter 72 is connected, they automatically switch to the adapter source and cut the power off from the solar panel 38.

In order to maximize battery life, the device 10 can operate in four different power management conditions. These are:
1) Active mode in which most of the components are powered and activated and the processor 44 operates at full speed
2) Standby mode, such as sniff mode, in which the processor 44 is placed into an idle condition with its clock shut off, and configured so that a trigger signal “wakes up” the processor 44
3) Sleep mode in which, in addition to the processor 44, unused peripherals are also shut off by the software product of the invention
4) Deep sleep mode in which all the PLL clocks inside the processor 44 are shut down with only a 32 kHz clock still running, the processor 44 being configured so that a trigger signal “wakes up” the processor 44.

Generally, alarm, security and home automation systems usually have a centre control panel and a keypad to control peripheral devices such as sirens, strobe lights and cameras. The device 10 is capable of combining the functions of these devices in one unit. In particular, the device 10 comprises the control centre and the peripheral devices 35 described above are switched wirelessly from the device 10, using, for example, the transceiver 22. As a result, the device 10 can be operated without a complicated set up of separate units, without wires and, importantly, no unnecessary wireless links between control panel, keypad and camera as is the case with presently available alarm systems and home automation systems.

The USB device port 54 and the controller 14 are configured to facilitate upgrading of the device 10 by using third-party USB products. Normally, USB devices work only when connected to a computer. In this embodiment, the USB devices can be connected to the device 10 and work independently from a computer. For example, the USB modem 20 can be connected to the USB port 52 and the modem driver software downloaded to the device 10 without the use of a computer.

In one embodiment, the device 10 includes a memory card reader. An SDIO-WiFi card is known as a low-power device and can be used instead of the USB modem 20 where shorter distance communication is required.

The digital camera 24 can include either a digital colour or black-and-white CMOS or CCD image sensor to record either video or still images. At the same time, the microphone 25 can record sound with the images. The image and sound data can be recorded onto a computer either through wireless transmission or by temporarily connecting the computer to the device 10. When still images are recorded, they are not recorded with sound as would be the case when video images are recorded. However, the microphone 25 can be operated by the controller 14 to record sound and store sound data in the memory 19.

The light sensor 27 provides data representing light intensity so that the camera 24 can adjust accordingly. Thus, the light sensor is set dependent on the location of the camera 24 in such a way that a compromise is found between a high dynamic range requirement and a high light sensitivity requirement. Both of these parameters are counter-current.

The light sensor 27 and the controller 14 are configured so that when ambient light conditions are at a predetermined low-level, the controller 14 actuates the infrared spotlight 36. In particular, the controller 14 is configured so that the spotlight 36 is switched on when movement is detected by the PIR 34 or 36. At that time, the camera 24 is configured to operate in black & white mode only. Thus, the infrared array 26 can detect infrared images representing the event to be recorded and/or observed.

The controller 14 is configured to time/date/location stamp and watermark each stored still image with an identification mark. As a result, when the images are processed, location of relevant images is facilitated by using the stamped data. The camera 24 is configured to record up to four JPEG (e.g. WVGA) still images per second. This image data can be processed so that in a user interface of the computer, a user can choose to view the images in a time lapse mode such that they can be scrolled through with a suitable viewer to facilitate location of various scenes.

With conventional systems, it is found that when recording video, devices can store video films which are hours and even days long. It will be appreciated that it is only at certain times that unauthorized incidents may occur. It follows that security personnel have to scan through excessive amounts of footage to find a single scene of an incident. This can be both time-consuming and frustrating. With the device 10, the controller 14 is configured so that markers are recorded into the memory. The markers can be generated by trigger signals generated by, for example, the motion sensor 34, the external sensor 28 or by a trigger button on the remote controller 40. It will readily be appreciated that other sensors can be used to generate trigger signals which would trigger the controller 14 to generate markers for recording into the memory. Using the markers, relevant video clips, or a sequence of still photos, can be transferred to a 25 separate folder in the memory to facilitate later searching and viewing.

It will be appreciated that JPEG image data uses up more memory space then MPEG files over the same duration. However, a photo image of a single frame extracted from the MPEG compressed video is not as clear as a still JPEG image. Thus, the camera 24 is configured to provide the user with a choice between two video formats, with tone or without tone according to the requirements of the particular application.

In one embodiment, image data, audio data or video data is transmitted to a number of cellular or mobile phones or monitor stations via a cellular network. Alternatively, this data can be transmitted to a plurality of computers, e-mail enabled cellular phones and monitor stations via WLAN protocols. The controller 14 is configured to instruct the modem 20 automatically to carry out such a transmission when the camera 24 is triggered by a sensor. Furthermore, the controller 14 is configured to instruct the modem 20 to send an alert SMS to at least one cellular phone.

The controller 14 is configured to receive SMS signals via the modem 20 from cellular phones. The controller 14 can decode SMS signals into instructions for various components of the device 10. For example, on receipt of such a signal, the controller 14 is configured to carry out at least the following tasks:
transmitting images or videos associated with a certain time/date to a particular recipient
switching equipment using the transceiver 22 such as the peripheral devices described above or further devices such as air conditioning units, heaters etc. or even triggering a further recording and surveillance device in a different location
various home automation tasks.

The controller 14 and the power management unit 18 are configured to monitor the batteries 74 and to generate a signal to be transmitted with the modem 20 to a monitoring station or mobile phones if the batteries reach a predetermined low charge. The controller 14 and the management unit 18 are also configured to perform troubleshooting operations on the device 10 and to generate a signal to be transmitted with the modem 20 to a monitoring station or mobile phones if any of the components are found to be faulty.

A number of scenarios are now described to illustrate some ways in which the device 10 can operate.

Scenario 1

The camera 24 is triggered into operation by the sensor 34. The camera 24 captures images or video clips which are recorded in an internal digital video recorder (DVR). Simultaneously, the device 10 transmits an alert SMS and still images or a video clip for verification by e-mail or MMS to one or more designated addresses.

All the video footage or still images and sound data stored on the internal memory or on a removable memory card can be viewed at a later stage with a suitable device such as a picture show viewer of the computer.

Scenario 2

The external PIR sensor 28, which is wireless, is placed in front of the entrance to a building and is triggered by an unauthorized event. The transceiver 22 receives the triggering signal and, in response, the controller 14 actuates the device 10 positioned inside the building. The camera 24 then begins recording. In one embodiment, a length of the recording in JPEG or MPEG is determined by prior settings of the device 10. For example, the recording may initially be for a predetermined length of time after which the camera 24 switches off. Should another trigger signal be received, the camera 24 is actuated again for the predetermined length of time. As before, the device 10 transmits 10 the alert SMS and image data for verification by e-mail or MMS to designated addresses.

Scenario 3

The sensor 34 of the device 10 is triggered by an unauthorized event. The camera 24 begins recording according to the device settings. The controller 14 stores images or video clips in the internal memory or in a removable memory card. At the same time, the device 10 uses the transceiver 22 to switch on the IR spotlight 35 which is wireless to facilitate infrared recording by the camera 24.

Scenario 4

The device 10 is positioned in a sensitive area, for example, where petrol tanks are stored. The gas sensor 32, which is wireless and the smoke detector 30, which is also wireless, are also mounted in that area. In the case of a gas leakage or fire, the device 10 uses the transceiver 22 to receive a triggering signal from either or both of those sensors. The controller 14 then activates the camera 24 to record images and video footage. At the same time, the modem 20 is used to transmit an alert SMS and a sequence or still images or video clips to one or more of the wireless communications devices 43 or the monitoring station 42.

Scenario 5

The device 10 is positioned above the cash register in a retail outlet. The wireless magnetic switch 33 is connected to the drawer of the cash register. When the drawer is opened, the camera 24 is actuated, as before. The sequence of images or video clips is stored on the internal DVR. At the end of a working day, an owner of the retail outlet 35 can observe operation of the cash register.

It will be appreciated that a retail chain may have hundreds of shops. Thus, it would not be possible to go to each location and view the images of the day individually. However, by using a wireless LAN at each shop, that communicates with the device 10 in the manner described earlier, an owner or security manager could access the images remotely via an Ethernet/Internet connection.

It will be appreciated that upgrade the device 10 can be achieved using the USB port 52. For example, the modem driver can be downloaded by the 14. As a result, the device 10 is capable of standalone operation without the need for a PC or other device.

A plurality of peripheral devices and further devices 10 can communicate with each other with a secure hopping frequency using associated identity codes. For example, a first device 10 at the entrance of a building can trigger other devices 10 in premises to activate and start recording. Furthermore, the first device 10 could trigger peripheral devices such as IR spotlights positioned in the premises. When such a plurality of devices 10 are used, they can transmit video footage and, if required, sound to a plurality of monitoring stations, PC's or cell phones.

One of the USB ports 52, 54 can be used to download images, video and sound that are stored on the internal memory and SD card/solid state drive to a computer for viewing.

One of the USB ports 52, 54 can be used for automatically exchanging firmware and set up software between the device 10 and a computer. Setup will be carried out on the computer's user interface screens.

The device 10 can include an AN OUT terminal. When connected to a conventional monitor, an installer is able to position the device 10 for optimum viewing angle and audio pick up.

The controller 14 is programmed with proprietary setup software to facilitate start of operation for various applications. For example, a setup screen provides an operator with general default settings and five other default settings typical for certain tasks. Thus, reference to manuals is obviated.

The covers 62 are configured to be weatherproof with optical lenses, windows and vents to protect the camera, light sensor and other internal peripherals.

In FIG. 13 reference numeral 110 generally indicates another embodiment of a surveillance and recording device, in accordance with the invention. With reference to the previous figures, like reference numerals refer to like parts, unless otherwise specified.

In this embodiment, the device 110 is configured for portable use, for example by a security guard, policeman or like personnel. This is facilitated by the fact that the device 110 is able to communicate wirelessly in substantially the same manner as the device 10.

The device 110 has a housing 112 which is shaped to fit into a pocket or other similar receptacle carried by the user. It will be appreciated that the device 110 will not 20 include the solar panel 38. Instead, the device 110 will be battery operated and can include rechargeable batteries 74 managed by the unit 18 in the manner described previously.

The microphone 25 is mounted in the housing 112 in a position in which it is not obstructed by the receptacle. For example, the microphone 25 is positioned, and the housing 112 shaped so that when the device 110 is received in the receptacle, the microphone is positioned outside of the receptacle.

The camera 24 is positioned in a similar manner to the microphone 25. The same applies to the light sensor 27.

It will be appreciated that the device 110 permits mobile recording and surveillance. The data generated by the device 110 can be transmitted to the monitoring station 42 in the manner described earlier.

In order to accommodate the nature of use, in this embodiment, the controller 14 may be programmed with the software product such that the camera 24 is set to continuously record while the wearer is in action.

Throughout the specification, including the claims, where the context permits, the term “comprising” and variants thereof such as “comprise” or “comprises” are to be interpreted as including the stated integer or integers without necessarily excluding any other integers.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

1. A surveillance and recording device which comprises:
a housing;
a controller arranged in the housing;
a recording device arranged in the housing and operatively connected to the controller, the recording device being capable of recording one of video and successive still images;
a memory arranged in the housing and connected to the controller to store data generated by the recording device;
a power management unit connected to the controller and configured to manage at least two sources of power;
at least one communications port connected to the controller, a communications port being configured at least for connection to a wireless modem to enable wireless communication with the controller from a remote location; and
a transceiver arranged in the housing and operatively connected to the controller to permit wireless communication with peripheral devices, the controller and the transceiver being configured so that the transceiver can receive trigger signals from the peripheral devices and transmit actuating signals to other peripheral devices on receipt of said trigger signals.

2. A surveillance and recording device as claimed in claim 1, in which the housing has a pair of covers, each cover including complementary connecting formations configured to permit assembly or disassembly of the cover by hand without the need for tools.

3. (canceled)

4. A surveillance and recording device as claimed in claim 1, in which an event sensor is arranged in the housing and is operatively connected to the controller such that the recording device can be actuated when an event is sensed by the sensor.

5. A surveillance and recording device as claimed in claim 4, in which the event sensor is a motion detector.

6. A surveillance and recording device as claimed in claim 1, in which the controller is configured to write data relating to event times to the memory in the form of markers to enable retrieval of data generated by the recording device at said event times.

7. (canceled)

8. A surveillance and recording device as claimed in claim 1, in which the communications port is in the form of a USB port, the controller being configured to permit plug 'n play operation of devices connected to the port.

9. A surveillance and recording device as claimed in claim 8, in which the controller is configured to communicate with one of a GSM, HSPA and WLAN modem and is configured to use wireless protocols.

10. (canceled)

11. A surveillance and recording device as claimed in claim 1, in which the controller and transceiver are configured so that the transceiver can assume a sniff mode to detect wireless signals at predetermined signals.

12. A surveillance and recording device as claimed in claim 1, in which the controller and transceiver are configured so that the transceiver can communicate with the peripheral devices using an encrypted hopping frequency.

13. A surveillance and recording device as claimed in claim 8, in which the controller is configured to generate a message according to a mobile messaging protocol carrying information relating to a peripheral device triggered by an event to be communicated by the wireless modem.

14. A surveillance and recording device as claimed in claim 8, in which the controller and modem are configured so that the modem is capable of receiving transmitted data representing instructions from a remote location.

15. A surveillance and recording device as claimed in claim 8, in which the controller is configured to communicate with the modem to receive instructions to extract data generated by the recording device from the memory and to communicate the data to computers or monitor stations via WLAN or to mobile devices via a cellular network.

16. A surveillance and recording device as claimed in claim 1, in which the power management unit includes a solar panel, two internal and separate rechargeable batteries and power management circuitry for controlling power from the two batteries and from the solar panel.

17. A surveillance and recording device as claimed in claim 16, in which the controller is operatively connected to the power management circuitry and programmed so that the power management circuitry controls power selection from either of the two batteries.

18. A surveillance and recording device as claimed in claim 16, in which the power management circuitry is configured to receive two sources of power, one from the solar panel and one from a DC source, the circuitry including a power path selector for selecting a power or current path either to power out or to a charging arrangement for charging the batteries.

19. A method for recording and surveillance of events using the device of claim 1, the method comprising the steps of:
actuating the recording device to be in a condition suitable for recording one of video and successive still images;
recording an event in the form of one of video and successive still images with the recording device on receipt of a trigger signal at the controller from a sensor;
processing data generated by the recording device; and
subsequent to processing the data, transmitting data representing one of the video and the successive still images wirelessly to a remote location with a wireless modem connected to the communications port.

20. A method as claimed in claim 18, which includes the step of receiving the trigger signal from a peripheral device operatively connected to the controller.

21. (canceled)

22. (canceled)

23. A surveillance and recording device as claimed in claim 1, which includes a microphone, the controller being configured to operate the microphone to record sound at the same time as the recording device records the still images and to store the sound data in the memory.

24. A method for operating the device of claim 1, the method comprising the steps of:
receiving a signal at the controller via the communications port; and
decoding the signal at the controller to generate instructions for components of the device, the instructions being configured so that the controller is configured to carry out at least one of transmitting data generated by the recording device with the transceiver and actuating peripheral devices.
